(19) United States
(12) Patent Application Publication
(10) Pub. No.: US 2020/0410619 A1
(43) Pub. Date: Dec. 31, 2020

(54) METHOD FOR PROVIDING SERVICES FOR FAMILIES OF TEENAGE PARENTS

(71) Applicant: Mayra Nelly Lopez Carrero, Bayamon, PR (US)

(72) Inventor: Mayra Nelly Lopez Carrero, Bayamon, PR (US)

(21) Appl. No.: 16/912,671

(22) Filed: Jun. 25, 2020

Related U.S. Application Data
(60) Provisional application No. 62/866,360, filed on Jun. 25, 2019.

(51) Int. Cl. G06Q 50/22; G06Q 50/20

(52) U.S. Cl. CPC G06Q 50/22; G06Q 50/20

(57) ABSTRACT

A method for providing education and counseling to families of teenage parents in order to improve and balance the physical, psychological, social and educational aspects of their lives. The method is executed in a series of steps that covers education and counseling to the teenage parents themselves, their parents, and their child. The method helps families avoid issues such as unplanned pregnancies, family violence, school desertion, and child abuse by implementing a series of professional interventions, guidance and courses in an order based on the family's specific needs.

### CROSS-REFERENCE TO RELATED APPLICATION

This application claims the benefit to U.S. Provisional Patent Application 62/866,360, filed Jun. 25, 2019, the contents of which are incorporated by reference herein.

### STATEMENT REGARDING FEDERALLY SPONSORED RESEARCH AND DEVELOPMENT

N/A

### BACKGROUND OF THE INVENTION

### Field of the Invention

The present disclosure relates to the field of education, socioemotional development, and training methodologies for families in order to achieve a healthy family environment, child development, and socioeconomic mobility. Specifically, the present disclosure is directed to a comprehensive method for providing teenage parents, their parents, and their children with the right tools to be able to balance the physical, psychological, social and educational aspects of their lives such that they benefit themselves as a family and society as a whole.

The present invention allows families with teenage parents to obtain the appropriate training, counseling and access to pertinent services and social support to ensure the family stays healthy, strengthening society at the same time. This is achieved by providing said families with counseling related to responsible parenting, avoidance of unplanned pregnancies, academic success, avoidance of family and community violence, and avoidance of child abuse.

### Background of the Invention

The concept of a family incubator is an adaptation of the foundations that support the operation of a baby incubator in the neonatal intensive area. A prematurely born baby does not depend on its mother to develop, but it is also incapable of evolving on its own. In itself, families of teenage parents require specialized services with a multidisciplinary work team in conjunction with the base family in order to achieve their independence.

To continue the parallel between a family of teenage parents born prematurely and a premature baby, we can talk about the functions. A premature baby needs to remain safe and isolated from germs and noise, for the amount of time that the doctors determine depending on the age of the baby, the level of development of its vital systems and according to how that specific newborn evolves. Some babies need to be kept inside the incubator for only a few hours to provide constant warmth and quiet insulation, while other very premature babies need to be kept there for months with special care. Not all families of teenage parents have the same needs, which is why services should be individualized and offered according to what they need to get out of their premature condition. When families can begin to take responsibility in different areas and make decisions, they must be guided and give full responsibility. This makes them mature and ready to assume the reins of their new assignment, be a healthy and independent family.

A family of teenage parents assumes instability and continuous emergency situations until they achieve a certain level of stability as a result of education and weaving of familiar and societal support nets. If during this period the work plan designed for that family is unbalanced, it is immediately amended to cover that specific need. In the cases of families of teenage parents, speed and the multidisciplinary work team that takes care of it are the key to success.

However, programs that support families cannot under any circumstances replace the families that provide the family of teenage parents. There must be teamwork and an orderly transition between the program, the base family, and the family of teenage parents. The end results are a healthy and empowered family of teenage parents, with successful children in schools, with the self-esteem of their members strengthened and with a bright future, contributing to their society. The impact to public policy and contextual environments of teen parent's families are also addressed due to the systemic nature of their needs.

For some families, the incubator is a cold method because it does not allow the mother to have much contact with the baby. It is important that these programs work with the base family to support and empower them and offer them what is necessary to fulfill their role when the family of teenage parents becomes independent. If the service program fails to make that transition with base families, families dependent on the program for life are created.

Education and socioemotional development are the basis for breaking the cycle of social disadvantage among families of teenage parents. The goal is to reduce school dropouts, unwanted pregnancies, domestic violence, child abuse, develop responsible parenting skills, among others. For this, it is important that the base family (parents, uncles, grandparents, friends) intervene and actively participate in the process, maturing and healing relationships, strengthening ties, increasing communication, creating bridges so that at the time of transition, these families can become independent and that the support of the base family is a healthy one.

### SUMMARY OF THE INVENTION

The present invention provides a method directed at effectively counseling and nurturing a family of teenage parents in order to overcome the physiological, psychological and social hurdles that these types of families generally face.

An object of the present invention is to aid base families in the process of forming their teenage children that become parents prematurely into functional, successful parents themselves, as well as contributing members of society.

A further object of the present invention is to provide families with teenage parents with the proper counseling to avoid issues such as unplanned pregnancies, family violence, school desertion, and child abuse.

The invention itself, both as to its configuration and its mode of operation will be best understood, and additional objects and advantages thereof will become apparent, by the following detailed description of a preferred embodiment taken in conjunction with the accompanying drawings.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the general public, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF SUMMARY OF THE DRAWINGS

The accompanying drawings, which are incorporated herein, constitute part of the specification and illustrate the preferred embodiment of the invention.

FIG. 1 shows a flowchart of the steps that provide a method for providing training and counseling to families according to the teachings of the present disclosure.

FIG. 2 shows a flowchart of the required steps to develop a Family Management Plan according to the teachings of the present disclosure.

### DETAILED DESCRIPTION OF THE INVENTION

An embodiment of the present invention includes a method that promotes family unity through guidelines that will be established for each participating family that forms part of the program. The guidelines aim to achieve a family team environment willing to support the teenage parents and work towards the children breaking with the cycle of socio-economic disadvantages.

Another embodiment of the present invention is a method for providing specialized services for teen parent's families. During a three (3) month period, professionals will gather information through standardized tests, psychosocial contextual background research, and home visits in order to develop an individualized Family Management Plan that integrates all the household's family members. To achieve sound and stable families, the method employs a Family Incubator Model academic curriculum that allows families to recognize their academic goals and objectives, to reach emotional stability and develop a vision for the future that breaks the cycle of social and economical disadvantage. The strategic areas of the method include: an early intervention workshop; a social area; an academic area; and further specialized services which includes sexual and reproductive health education amongst other services.

The Family Incubator Model (FIM) academic curriculum considers learning a deliberate act and that learning allows students to connect with reality, as it pertains to their parenting, head of household, responsible citizen, first-educator, and college student roles. To create multisensorial experiences, and that all family members (grandparents, parents and children) may have an opportunity to achieve academic goals and/or develop new abilities. The FIM academic curriculum aims for the participants to learn to achieve sustained conclusions informed by research, learn to regulate conduct through executive function, develop cognitive flexibility, develop inhibition, develop proper motorization, develop planning skills, develop a work memory, develop sound decision making and problem resolution skills, and develop a competence for facing obstacles. This allows participants to obtain new opportunities in life. The curriculum will identify and develop the participant's intelligence though the use of individualized techniques which in turn will allow the participant to develop a healthy self-esteem, an appropriate use of executive functions and to develop competently in life. Facilitators of these methods are experts in the areas of interest and not necessarily teachers.

An additional embodiment of the method comprises early intervention for the children of teenage parents. The workshop is handled through a creative curriculum split for children ages 0-3 and those in preschool and elementary school. For children ages 0-3, the Creative Curriculum bases decisions made for infant care upon knowledge of infant development and learning, needs, strengths and interests of each child, and the social and cultural environment in which the child lives. The curriculum developed for preschool and elementary school students is based upon the positive relations and interactions the child can have with adults, the significance of the socioemotional competence for school achievements, deliberately constructive games that induce learning, the physical environment and its effect on learning, and that the collaboration between parents and teachers encourages better development and learning. The curriculum guides the interactions to be had with children and their families and is enriched by the use of learning materials and technological equipment. These interactions are supplemented with the FIM academic curriculum through its parenting and grandparenting skills courses, as the workshop provides a setting to practice theoretical knowledge gained by the teen parents and grandparents.

Yet another embodiment of the method includes following-up, using specific socioemotional and support services, with college-level participants. This method attends to the basic needs of participants that are in the process of adapting to the college life and workload. Participants will be required to present evidence of grades and enrollment in semesters in order to document and assess progress.

A further embodiment of the method comprises strategies developed for preventing teenage pregnancies. This component is adapted to the individualized needs of participants based on different risk levels and their exposure to sexual and reproductive knowledge and conduct.

Another embodiment of the present method comprises a logical framework designed to have an effect on three generations (grandparents, teenage parents and the children). The effectiveness of the method is evaluated through increasing the protective factors throughout the life of the course, achieving nurturing family environments and increasing socioeconomic position.

An additional embodiment is the family incubator model and its key elements. The model considers the individual physical, educational, social and psychological aspects of the participating families in order to strengthen healthy family relations which contribute positively to the development of the children and teenagers. The model aims to increase life-course protective factors for families by reducing unplanned pregnancies, achieving children's academic success, and responsible parenting skills; as well as strengthening family environments by reducing community and domestic violence and infant abuse, also increasing social mobility, by reducing school dropout rates, governmental aid's dependency, and increasing first generation of college students.

Further embodiments of the present invention may include services provided such as community outreach, alternative educational methods, early intervention programs, specialized services, development of parental skills, birthing classes, and psychological tests and therapies.

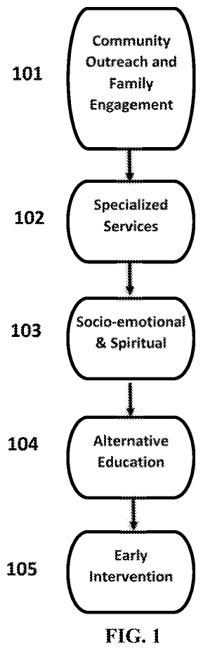

FIG. 1 shows a flowchart of an embodiment of the present invention. The first step 101 focuses on community outreach and family engagement. In this step, an assessment is made to determine which teen parent's families in a community may benefit from counseling and education due to their current situation. The objective is to educate and train all three generations (grandparents, teenage parents, and children) in order to ensure a completely healthy environment for all the members of the teen parent's family. Once a family is determined to be a proper candidate for training and counseling, the specialized services step 102 starts. In specialized services step 102 the professionals gather data by visiting the teen parent's family homes in order to assess perceived, immediate and long-term needs, their socioemotional stability, and studying competences. The family members undergo various standardized psychological tests to assess the: intellectual coefficient (verbal and executive), visual and motor skills, socioemotional status (perception, anxiety, others), academic and vocational interests. This step provides more specialized services offered to the families based on their specific situations in order to develop a Family Management Plan to be carried out individually by the family. These specialized services allow the family to focus on the challenges that are particularly difficult to overcome.

During this in step 102 period, every interview, session, and test that the family goes through is documented in order to assess and address the family's strengths and areas of opportunity. This step is implemented as a collaboration between several professionals (doctors, social workers, psychologists, teachers) to study the family for a period of time, maximum of 3 months and minimum of 2 weeks, in order to determine what are the specific needs of the teenage parent's families and offer the appropriate courses. Several teenage parents from different families but with similar needs may be grouped together in a course.
The next step 103 in the method is directed at the socioemotional and spiritual aspects of the families' lives by visiting their homes in order to assess progress and further needs. This step may also include psychological therapy sessions, interviews, workshops and spiritual guidance. The services in this step may be continued as needed by the family.

A further alternative education step 104 is guided by the Family Incubator Model (FIM) academic curriculum, to ultimately provide pertinent competencies and for teen parents to obtain their high school diploma. The courses in the FIM academic curriculum offer a range of competencies and skills from teaching teen parents to be their child's first teacher, being a responsible citizen, becoming a provider for the family, and being the head of the family. The curriculum provides for the core classes such as Math, Science, Language Arts (Spanish and English), and History to be complemented by other pertinent courses such as: Socioemotional Development, Family Sciences, Conflict Management, Parenting Skills, and Elective courses (Sexual and Reproductive Health course, Microentrepreneurship and Employability courses, Creativity and others). These courses are directed at promoting the family's social inclusion, for example:

1. Parenting Skills

For teen parents with children and expecting parents. The course helps develop the parent as the child's first educator. This course requires the active participation of teen parents to learn early development techniques that will help them systematically teach their children. This course is included in the FIM academic curriculum and may be offered by a preschool teacher and is nourished by testimonies from the participants. The following goals are expected to be achieved: educational gain for the parents and for the baby, emotional attachment between parents and children, individualized training from the different early learning and development professionals, baby's development assessment by their parents, among others.

2. General Life Skills

It covers basic skills of their new role as adults such as: obtaining their driver's license, shopping at the supermarket, serving a table, among others. These examples show why the present method is directed specifically at families with teenage parents.

3. Family Life Skills

Basic communication skills, values, crisis management, emergency plans, and healthy sexual relationships are covered.

4. Employability Skills

Employability skills range from technical skills such as cooking, baking, aquaponics, etc. until they have the opportunity to develop in a job.

The final step 105 is directed at early intervention with the teenage parents and their children by employing a specialized curriculum that focuses on children from 0 to 3 years old and preschool education. This curriculum includes all aspects of a developmentally appropriate program and guides the family through the process of planning activities, providing excellent care and education for children from birth to Kindergarten. In addition, an in-house pediatrician provides preventive well-baby evaluations weekly. Other healthcare providers such as ophthalmologist, dentists, and audiologists, assess the children as needed to provide an early intervention that promotes appropriate and optimal child development.

The curriculum for children from 0 to 3 years old shows how to apply appropriate practices at the developmental level. In addition, it teaches teenage parents to make decisions regarding child care and education based on information in three areas: (i) knowledge of child development and how children learn; (ii) knowledge of the needs, strengths and interests of each child; and (iii) knowledge of the social and cultural context in which the child lives.

The curriculum for preschool education is based on five fundamental principles:
Positive interactions and relationships with adults provide crucial foundations for successful learning.
Socioemotional competence is a significant factor in academic achievements.
Constructive and deliberate play supports essential learning.
The physical environment affects the type and quality of learning interactions.
Parent-teacher collaboration fosters development and learning.

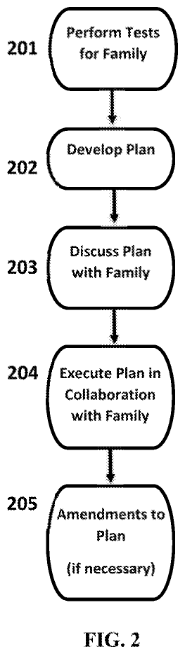

As shown in FIG. 2. during the course of the aforementioned steps, a Family Management Plan (FMP) is developed in order to allow the family to continue its development by addressing the most relevant aspects for their specific case. During a period of approximately three months, the professionals will dedicate themselves to collecting information, either through standardized psychological and educational tests and/or home visits 201 in order to prepare the FMP that integrates all the members of those families' households, including both sides of the teen parents' families. The strategy to develop the FMP 202 is to carry out an individualized analysis that can be used to determine the scope, order of priorities and the approximate time of the impact on the families of teenage parents. At the end of this 202 the professionals establish the level of emotional compromise exhibited by each family by using a 5-points Likert scale (where 5 represents highly emotional compromise); which is used to determine the dose of services for the family. During this period 203, the perceived needs of families and the real needs identified by skilled program staff will be addressed. Activities that promote family union will be provided to families; recreation; family dialogue, between peers and professionals; intensive psychological therapies; breaks; balanced nutrition; courses that allow the mother to acquire skills and start working with identified priority situations, such as communication in couples or prenatal health. After the FMP is prepared 204, the participant is ready to continue with the individualized strategic design developed for the family. The home visit and collateral interviews provide insight into the family environment that will help visualize any problems. Further home visits from professionals and feedback obtained from any intervention with the family may lead to amendments 205 to the FMP in order to better align the plan with the family's needs. Such amendments may include social worker visits, academic program adjustments, tutoring, psychological treatment sessions, meetings with teachers, external resources psychiatric referrals, and workshops covering any of the areas mentioned throughout the present disclosure in which a family is deemed to have deficiencies.

Among the strategies developed to achieve healthy families, a professional institution may provide its own model curriculum, which guarantees individualized work to achieve the objectives developed for each family. The four strategic areas of the model are: early intervention workshop, social area, academic area, and specialized services (sexual and reproductive health, among others). The academic area is an opportunity for families to reorganize their academic goals and objectives and redirect themselves by assuming and facing an additional challenge beyond acquiring a university career, which is to develop a healthy family. The fact that a participant stabilizes emotionally and develops a vision of the future guarantees to break the cycle of social and economic disadvantage.

Although certain exemplary embodiments and methods have been described in some detail, for clarity of understanding and by way of example, it will be apparent from the foregoing disclosure to those skilled in the art that variations, modifications, changes, and adaptations of such embodiments and methods may be made without departing from the true spirit and scope of the claims. Therefore, the above description should not be taken as limiting the scope of the invention which is defined by the appended claims

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means plus function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

1. A method for providing services to a family of teenage parents, comprising the steps of:
assessing, through community outreach and family engagement, said family's need for counseling;
gathering data from said family by providing specialized services based on said need for counseling;
assessing progress and further needs after providing said specialized services;
providing further services to said family directed at socioemotional and spiritual needs;
providing alternative education to said family; and
providing early education to said family's teenage parents directed at proper child care and development.

2. The method of claim 1, wherein said specialized services comprises periodically visiting said family's home.

3. The method of claim 1, wherein said gathered data from said family comprises one or more of: intellectual coefficient, visual and motor skills, socioemotional status, academic and vocational interests.

4. The method of claim 1, wherein the step of gathering data from said family by providing specialized services is implemented by having a plurality of professionals study said family for a period of time.

5. The method of claim 1, wherein said services directed at socioemotional and spiritual needs comprise one or more of psychological therapy sessions, interviews, workshops and spiritual guidance.

6. The method of claim 1, wherein said alternative education comprises core classes.

7. The method of claim 1, wherein said alternative education comprises one or more classes directed at the following subjects: socioemotional development, family sciences, conflict management, parenting skills, sexual and reproductive health, microentrepreneurship, employability, and creativity.

8. The method of claim 1, wherein said early education comprises a specialized curriculum that focuses on children from 0 to 3 years old and preschool education.

9. The method of claim 1, wherein said early education comprises a specialized curriculum that focuses on children from 0 to 3 years old and preschool education.

10. The method of claim 1, further comprising the step of developing a Family Management Plan.
